(19) United States
(12) Patent Application Publication
(10) Pub. No.: US 2009/0025883 A1
(43) Pub. Date: Jan. 29, 2009

(54) Essential nomenclature safety labeler (ENSL)

(76) Inventors: Alexander K. Arfaras, Lutz, FL (US); Bruce Allen Sizemore, Tampa, FL (US); Wanda I. Rosa Arfaras, Lutz, FL (US)

Correspondence Address: Alexander K. Arfaras, 2234 Groveland Drive, Lutz, FL, 33549, US

(21) Appl. No.: 12/218,201

(22) Filed: Jul. 12, 2008

Related U.S. Application Data
(60) Provisional application No. 60/949,272, filed on Jul. 12, 2007.

(51) Int. Cl. B65C 9/26

(52) U.S. Cl. 156/391

(57) ABSTRACT

This invention relates to a device that will correct a systemic problem, and enhance patient safety in the areas of pharmaceutical packaging and the subsequent administration. More specifically, the invention will insure that essential nomenclature, which is often discarded, stays with the medication container throughout its clinical life.

### FIELD OF INVENTION

This invention relates to a device and methodology that addresses in order to correct systemic problems in the fields of patient safety, pharmaceutical packaging, labeling, administration and dispensing. More specifically, the invention will ensure that essential nomenclature, which is often separated and discarded, stays in physical contact with the medication container as mandated by standards and common practices throughout its clinical life.

### BACKGROUND

There is a serious industry wide problem that causes numerous medication errors every year. They result in needless pain, suffering and death and also much time money and litigation. The problem is most acute in the retail and long term care pharmacy setting, (drugs used in out patient or home setting). This system generally works like this; a prescription is filled by a professional in a pharmacy, where as a matter of policy (FDA regulations), a label is affixed to the container holding the medication. This mandated label is called the “Patient Dispensing Label”. The PDL contains the information deemed essential for the safe use and administration of the drug. The label is then affixed to the container in a semi permanent fashion, so that the essential nomenclature is always present at the time of administration.

The problem in this system comes into play when drugs are packaged (necessarily) in small and or irregular containers, e.g. insulin vials, ophthalmic drops, otic and other drugs. In the case of these drugs the manufacture generally ships these in a secondary container, e.g. cardboard box, crush proof plastic etc. these are of sufficient size to affix the required manufactures information, when they are shipped to the pharmacy the pharmacy then has to affix the PDL to the secondary shipping container for lack of anywhere else to do so. When the drug is issued to the patient and taken home the secondary container is much of the time thrown away, lost or discarded along with the information that is essential for its safe use and administration. The ENSL device will become one with the primary medicine container making them essentially one unit, allowing full visualization of the primary container and its labeling, and also adding sufficient space necessary to affix any and all essential nomenclature required for the safe use, dispensing, storage etc. of the medication enclosed.

### BRIEF DESCRIPTION

For the purpose of facilitating and understanding of the subject matter sought to be protected, there are illustrated in the accompany of drawings embodiments thereof, from an inspection of which, when considered in connection with the following description, the subject matter sought to be protected, its construction and operation, and many of its advantages should be readily understood and appreciated.

FIG. 5 is a hollow cylinder safety labeler (ENSL) comprised of transparent material . . . .

5G is the opening at top of cylinder of (ENSL) allowing access to hub/port of medication container.

5Z is shoulder of (ENSL) safety labeler.

5H is upper portion of cylinder label holder (ENSL) were medication container is secured.

5V is a removable, adjustable, locking plunger, inside cylinder of label holder (ENSL) that fastens medication container.

5J is bottom outside wall of safety labeler (ENSL) where patient dispensing label adheres.

5K is (ENSL) stand feature.

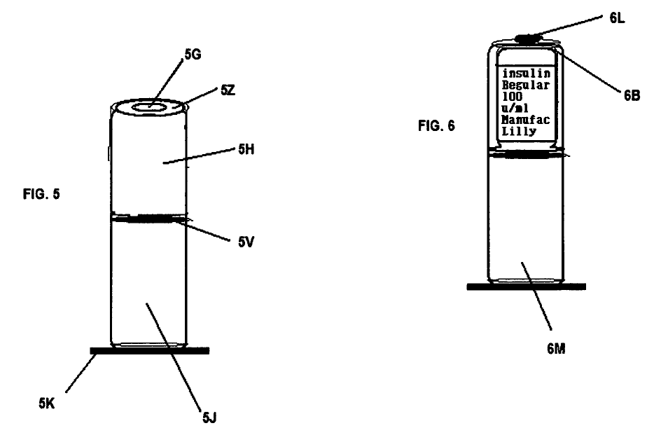

FIG. 6 is (ENSL) safety labeler with vial secured in final position.

6L shows opening at end of cylinder allowing for penetration of hub through the main cylindrical body and also allowing access to the hub for medication dispensing proposes.

6B is (ENSL) safety labeler and vial making shoulder to shoulder contact.

6M is hollow compartment of (ENSL) inside the cylinder were package insert and or accessories can be stored.

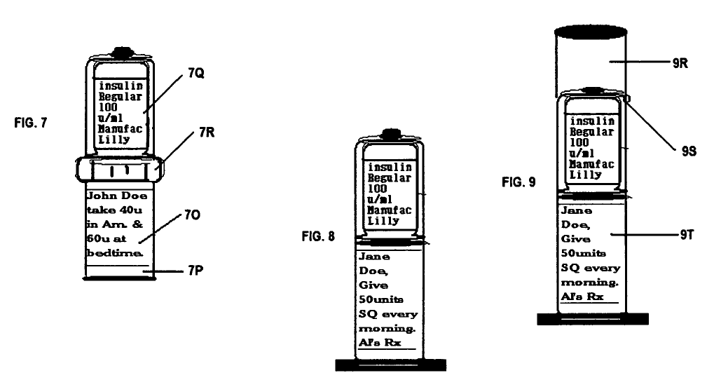

FIG. 7 is a safety labeler (ENSL) variation with a dram pill container functioning as cylindrical body with PDL attached, closed at bottom.

7R shows variation of ENSL with cap of dram bottle comprising a locking mechanism for vial.

7O shows PDL location on dram bottle variation of the ENSL.

FIG. 8 shows standard prototypical ENSL in an operational ready to use condition with PDL and vial in a ready to use location within and on the device.

9R shows ENSL variant comprising a tamper resistant device over the hub or dispensing end.

9S is the (ENSL) tampered evident clip feature.

9T is patient dispensing label.

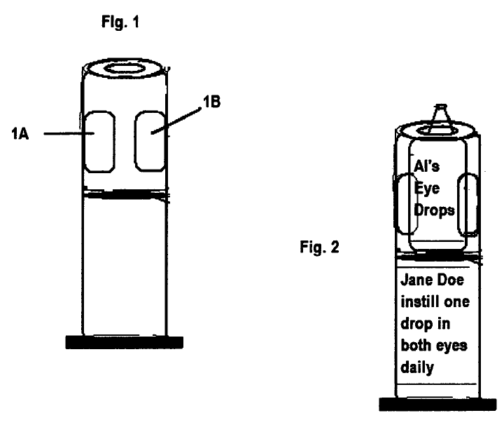

FIG. 1 shows ENSL variant to be used with medication containers requiring squeezing container to dispense medication. This variant is comprised of slots longitudinally cut in cylinder body.

1A & 1B shows the longitudinal openings which comprise access in order to squeeze medication container as described in FIG. 1

### DETAILED DESCRIPTION OF INVENTION

Current prototypes of the device are comprised of a hollow cylinder. The cylinder is comprised of a clear material suitable for clinical use. The opacity of the material is such that the contents of the medication container and any nomenclature contained in the cylinder body can be readily seen and or scanned through the cylinder walls. Current models are comprised of a hollow cylindrical body, open at one end to allow for the insertion and unencumbered passage of a medication container, e.g. (multi dose vial) through its length. The opposite end of the cylinder will be shouldered and have an opening of sufficient size and configuration as to allow access to the dispensing hub. Once the medicine container/vial is in this final position in the cylinder, e.g. shoulder to shoulder a locking device will secure the vial in position, the length of the cylinder is comprised by adding the lengths of the medication container, labels and locking devices et al. Variants of the device will comprise accommodations for differences in the size, shape and modality of the containers to be used with the device.

1. The invention is a device suitable for labeling hard to label medical containers.

2. The device is comprised of hollow tube open at both ends.

3. The body is open on one end to allow for medication containers to be inserted.

4. The tube will be of a diameter that allows a medication container et al. to pass through its length unencumbered.

5. The opposite end of the body is comprised of an opening that will allow access to the hub or despising side of the inserted container.

6. Hub access side of cylinder shall have shoulder sufficient to stop inserted container from passing through and out of body.

7. The device is comprised from a clear material that allow for clear visualization of inserted objects and any attached nomenclature.

8. The device will be comprised with a mechanism for securing in place, medication containers inserted therein.

9. The device will encapsulate and make objects inserted in the body, as one, with the rest of the device.

10. The device will comprise tamper resistant features as necessary.

11. Variants of the device will comprise accommodations for differences in the size, shape and modality of the containers to be used with the device

12. The device in “a preferred embodiment” will:
A. Allow hard to label pharmaceutical and their containers to be labeled consistent with current regulations and standard practices.
B. Reduce and or eliminate medication errors caused by missing essential nomenclature.
C. reduce pain and suffering by reducing/eliminating medication error.
D. Reduce and or eliminate litigation medication error.
E. ensures that the essential nomenclature stays in physical contact with the medication through its clinical life.

13. The invention is a device that allows for labeling small and or irregular shaped medication containers that heretofore could not be labeled consistent with best practices and or industry standards due to their small and irregular shape.
Current prototypes of the device may consist of a hollow cylinder(s). The opacity of the cylinder is such that the contents of the cylinder can be clearly seen and or bar coding can be read by a scanner. Cylinder body may be open at one end to allow for the insertion and unencumbered passage of a medication container, e.g. (multi dose vial) through its length. The opposite end of the cylinder will be shouldered and have an opening of sufficient size and configuration as to allow access to the dispensing hub of the medication container. Once the medicine container/vial is in this final position in the cylinder, e.g. shoulder to shoulder a mechanical device may be used to secure the vial in position, e.g.: plunger inserted in cylinder behind the vial or threaded capping device. The overall length of the cylinder is determined by adding the lengths of the medicine container, (unobstructed in the cylinder) plus the length of the label(s) to be attached plus miscellaneous length required for the locking devices and or thickness of plastic. Variants of this may comprise accommodations for differences in size, shape and modality of the containers to be used with the device.

14. The device of claim 13 may be comprised with a mechanical mechanism(s) for securing medication containers within its hollow cylindrical body.

15. The device of claim 13 will encapsulate and make medication containers inserted into the body, as one with the rest of the device.

16. The device may encompass tamper resistant mechanisms consistent with standards and practices.

17. A variant of device of claim 13 further comprises the ability to be used with containers requiring squeezing; this variant is comprised of slots longitudinally cut in cylinder body to provide finger access.

18. Further more a variation of claim 13 may comprise a threaded clear cylindrical body attaching to dram pill container as its cap.

19. The device of claim 13 in its preferred embodiment will:
A. Ensure that essential nomenclature stays in physical contact with the medication throughout its clinical life.
B. Reduce and or eliminate medication errors caused by missing essential nomenclature(s)
C. Reduce pain and suffering by reduction and or elimination of medication errors.
D. Reduce litigation caused by medication error.
